(19) United States
(12) Patent Application Publication
(10) Pub. No.: US 2016/0161699 A1
(43) Pub. Date: Jun. 9, 2016

(54) LENS MODULE

(71) Applicant: SAMSUNG ELECTRO-MECHANICS CO., LTD., Suwon-si (KR)

(72) Inventor: In Gun KIM, Suwon-si (KR)

(73) Assignee: SAMSUNG ELECTRO-MECHANICS CO., LTD., Suwon-si (KR)

(21) Appl. No.: 14/946,281

(22) Filed: Nov. 19, 2015

(30) Foreign Application Priority Data
Dec. 4, 2014 (KR) 10-2014-0173398

(51) Int. Cl. G02B 7/00; G02B 7/02

(52) U.S. Cl. CPC G02B 7/003; G02B 7/021

(57) ABSTRACT

A lens module including a first lens having a first extension part extending from an outer edge of the first lens; a second lens disposed on the first lens and contacting an inner peripheral surface of the first extension part; and a third lens disposed on the second lens and contacting a lower surface of the first extension part.

### CROSS-REFERENCE TO RELATED APPLICATION(S)

This application claims the priority and benefit of Korean Patent Application No. 10-2014-0173398 filed on Dec. 4, 2014, in the Korean Intellectual Property Office, the entire disclosure of which is incorporated herein by reference for all purposes.

### BACKGROUND

1. Field

The present disclosure relates to a lens module.

2. Description of Related Art

A lens barrel accommodating a plurality of lenses is provided in a lens module used for a camera module. The plurality of lenses are inserted into the lens barrel and fixed thereto. Optical axes are formed at the centers of the plurality of lenses, respectively. Since misaligned optical axes of the plurality of lenses have a negative effect on resolution, the optical axes of the plurality of lenses need to be aligned so as not to be misaligned with each other. However, when assembling the plurality of lenses in the lens barrel, assembly deviation may occur, and thus the optical axes of the plurality of lenses may be misaligned with each other.

Therefore, there is a need for a structure capable of stably fixing the plurality of lenses in a lens barrel in order to significantly reduce assembly deviation which may occur during the process of assembling the plurality of lenses.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens module capable of preventing an occurrence of assembly deviation during a process of assembling lenses.

According to an aspect of the present disclosure, a first lens, a second lens, and a third lens may be sequentially laminated in a lens module, wherein the second lens may be disposed in a space surrounded by the first lens and the third lens, and thus the second lens may be stably fixed thereto.

Accordingly, an occurrence of assembly deviation during a process of assembling lenses may be prevented.

In another general aspect, a first lens having a first extension part extending from an outer edge of the first lens; a second lens disposed on the first lens and contacting an inner peripheral surface of the first extension part; and a third lens disposed on the second lens and contacting a lower surface of the first extension part.

Other features and aspects will be apparent from the following detailed description, the drawings, and the claims.

### BRIEF DESCRIPTION OF DRAWINGS

FIG. 1 is a cross-sectional view of a lens module;

FIG. 2 is an enlarged view of box A of FIG. 1;

FIG. 3 is a cross-sectional view of a first lens;

FIG. 4 is a cross-sectional view illustrating a first lens and a second lens coupled to each other;

FIG. 5 is a cross-sectional view illustrating a first lens, a second lens, and a third lens coupled to each other;

FIG. 6 is a cross-sectional view of a lens module; and

FIG. 7 is an enlarged view of box B of FIG. 6.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Unless indicated otherwise, a statement that a first lens is “on” a second lens, a third lens or component is to be interpreted as covering both a case where the first lens directly contacts the second lens, third lens or the component, and a case where one or more other lenses are disposed between the first lens and the third lens or the component.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second lens disposed between a first lens and third lens based on the orientation of the device illustrated in the drawings also encompasses the device when the device is flipped upside down in use or operation,

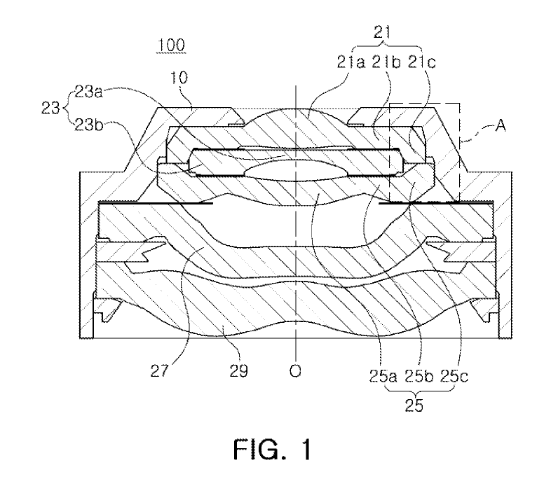

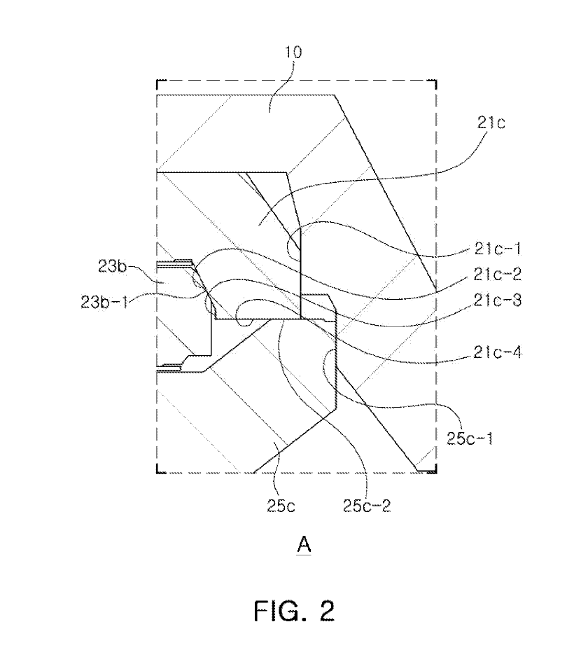

An optical axis O defines a vertical direction in relation to a lens barrel 10. FIG. 1 is a cross-sectional view of an example of a lens module, and FIG. 2 is an enlarged view of part A of FIG. 1.

Referring to FIGS. 1 and 2, a lens module 100, includes a lens barrel 10 and a plurality of lenses 21, 23, 25, 27, and 29 disposed in the lens barrel 10 along the optical axis O. The lens barrel 10 has a hollow cylindrical shape so as to accommodate the plurality of lenses 21, 23, 25, 27, and 29, and the plurality of lenses 21, 23, 25, 27, and 29 may be provided in the lens barrel 10 along the optical axis O.

A number of the plurality of lenses 21, 23, 25, 27, and 29 may be laminated depending on a design of the lens module 100, and the lenses may have optical characteristics such as the same refractive index, or different refractive indices.

The plurality of lenses 21, 23, 25, 27, and 29 are spaced apart from each other by a predetermined gap. Spacers may be provided between the plurality of lenses 21, 23, 25, 27, and 29 to maintain the gap between the lenses. The spacers may be provided as a film, or may be provided in a shape having a predetermined thickness. The spacers may be coated with a light blocking material, or a light blocking film may be attached thereto, to prevent unnecessary incident light from being transmitted through the spacers. In addition, the spacers may be formed of an opaque material. For example, the spacers may be formed of a nonferrous metal such as copper, or aluminum, or any combination thereof. In this case, the spacers may be easily formed and costs required for the manufacturing of the spacers may be reduced.

Referring to FIG. 1, although the present example illustrates a lens module with five lenses, the number of lenses is not limited thereto. For example, the number of lenses may vary, depending on the required resolution of the lens module.

Performance of an optical system including the plurality of lenses is influenced by lenses close to an object side. The object side is the side of the lenses and lens module which is directed to a subject to be photographed. The object side in FIGS. 1-7 is considered to be the top of the module. Therefore, hereinafter, a description will be provided based on the first, second, and third lenses sequentially disposed from the object side. For example, a lens closest to the object side will be referred to as a first lens 21, and a lens disposed on the first lens 21 along the optical axis O will be referred to as a second lens 23. In addition, a lens disposed on the second lens 23 along the optical axis O will be referred to as a third lens 25.

The first lens 21, second lens 23 and third lens 25 have the optical axis O formed at the center thereof, and includes optical parts 21a, 23a, and 25a refracting incident light reflected from the subject and ribs 21b, 23b, and 25b extended from the optical parts 21a, 23a, and 25a to the outer radial sides thereof, respectively. The second lens 23 is coupled to the first lens 21. For example, the second lens 23 is coupled to the first lens 21 while the first lens 21 encloses the second lens 23. The first lens 21 includes a first extension part 21c extended from an outer edge of the first lens 21, and an outer peripheral surface of the second lens 23 is in contact with an inner peripheral surface of the first extension part 21c. Here, the outer edge of the first lens 21 is defined as an outer edge of the rib 21b of the first lens 21, and the outer peripheral surface of the second lens 23 is defined as an outer peripheral surface of the rib 23b of the second lens 23.

In addition, the first lens 21 is coupled to the lens barrel 10. As seen in FIG. 2, an outer peripheral surface 21c-1 of the first extension part 21c is in contact with an inner peripheral surface of the lens barrel 10, and thus the first lens 21 and the lens barrel 10 may be coupled to each other. Here, an inner peripheral surface of the first extension part 21c may include a first tapered surface 21c-2 inclined at a predetermined angle in relation to the optical axis O.

According to FIG. 2, the outer peripheral surface of the second lens 23 includes a first inclined surface 23b-1 inclined to contact the first tapered surface 21c-2. The first tapered surface 21c-2 and the first inclined surface 23b-1 are inclined at the same angle as each other in relation to the optical axis O. Accordingly, the first tapered surface 21c-2 and the first inclined surface 23b-1 are in contact with each other, and thus the second lens 23 is coupled to the first lens 21. The rib 21b of the first lens 21 and the rib 23b of the second lens 23 may be indirectly contact each other through a spacer.

The inner peripheral surface of the first extension part 21c includes a vertical surface 21c-3 extending from the first tapered surface 21c-2 in the direction of the optical axis O. Here, the outer peripheral surface of the second lens 23 does not contact the vertical surface 21c-3. For example, the outer peripheral surface of the second lens 23 and the vertical surface 21c-3 is disposed so as to be spaced apart from each other in a direction perpendicular to the optical axis O. The vertical surface 21c-3 may serve to guide the first inclined surface 23b-1 of the second lens 23 to contact the first tapered surface 21c-2 when the second lens 23 is coupled to the first lens 21. Therefore, the outer peripheral surface of the second lens 23 and the vertical surface 21c-3 are spaced apart from each other, and thus a tolerance thereof may be easily managed.

The third lens 25 is coupled to the lens barrel 10, disposed on the second lens 23 and in contact with the first lens 21. For example, the third lens 25 includes a second extension part 25c extending from an outer edge of the third lens 25 towards the first extension part 21c, and an upper surface 25c-2 of the second extension part 25c contacts a lower surface 21c-4 of the first extension part 21c. The lower surface 21c-4 of the first extension part 21c and the upper surface 25c-2 of the second extension part 25c may be each perpendicular to the optical axis O.

The outer edge of the third lens 25 is defined as an outer radial edge of the rib 25b of the third lens 25. An outer peripheral surface 25c-1 of the second extension part 25c contacts the inner peripheral surface of the lens barrel 10, and thus the third lens 25 and the lens barrel 10 are coupled to each other. Here, the rib 25b of the third lens 25 and the rib 23b of the second lens 23 may indirectly contact each other through the spacer. Accordingly, the second lens 23 is fixed between the first lens 21 and the third lens 25.

As described above, the first lens 21 and the third lens 25 are coupled to the lens barrel 10, and may contact each other. Accordingly, the second lens 23 is disposed in a space between the first lens 21 and the third lens 25, and is fixed in the space.

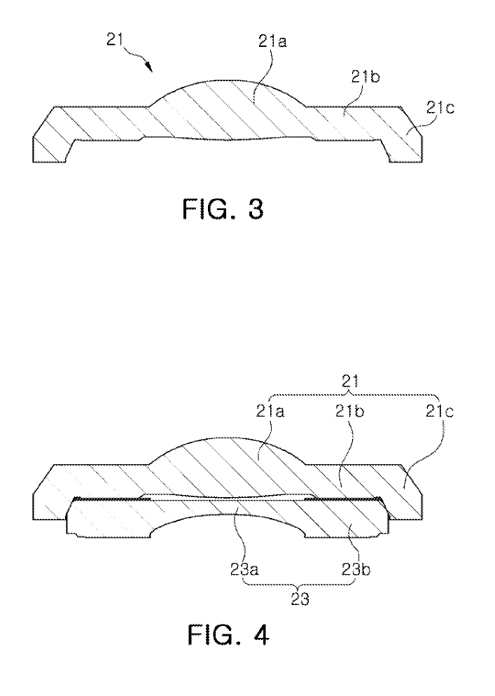

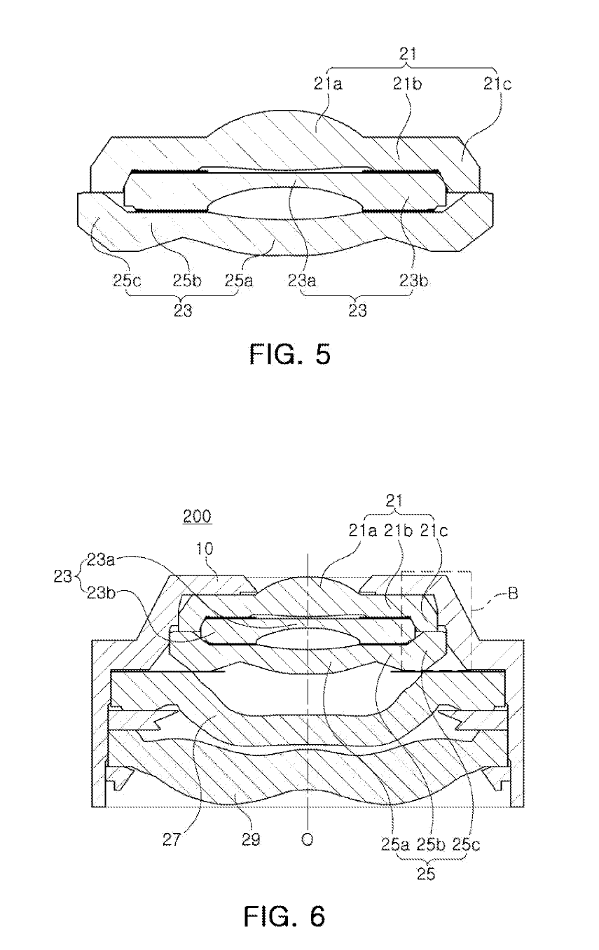

FIG. 3 is a cross-sectional view of an example of a first lens, FIG. 4 is a cross-sectional view illustrating an example of a first lens and a second lens coupled to each other, and FIG. 5 is a cross-sectional view illustrating an example of a first lens, a second lens, and a third lens coupled to each other.

Referring to FIGS. 3 and 4, the first lens 21 and the second lens 23 may be coupled to each other while the first lens 21 encloses the second lens 23. As described above, the first tapered surface 21c-2 of the first lens 21 and the first inclined surface 23b-1 of the second lens 23 contact each other. In addition, the rib 21b of the first lens 21 and the rib 23b of the second lens 23 may indirectly contact each other through the spacer.

Referring to FIG. 5, the third lens 25 is coupled to the second lens 23 and is disposed thereon. The first extension part 21c of the first lens 21 and the second extension part 25c of the third lens 25 contact each other. The third lens 25 is disposed on the second lens 23. The rib 23b of the second lens 23 and the rib 25b of the third lens 25 may indirectly contact each other through the spacer. Therefore, the second lens 23 is fixed in the space between the first lens 21 and the third lens 25.

As shown in FIG. 1, the first lens 21 and the third lens 25 are fixed to the lens barrel 10, and the second lens 23 is fixed in the space between the first lens 21 and third lens 25. Therefore, even though the second lens 23 is not coupled to the lens barrel 10, the assembly deviation which may occur during a process of assembling the lenses may be prevented in advance.

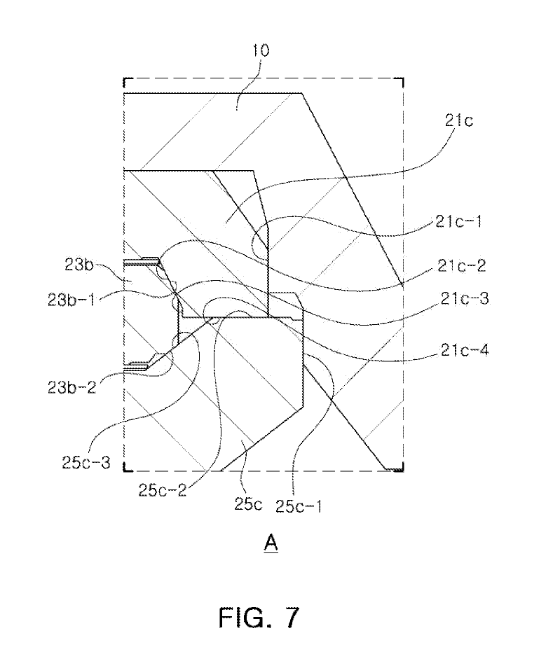

FIG. 6 is a cross-sectional view of an example of a lens module and FIG. 7 is an enlarged view of part B of FIG. 6.

Referring to FIGS. 6 and 7, an example lens module 200 has the same or similar structures as the example lens module 100 described above, except for a coupling structure between the second lens 23 and the third lens 25. Therefore, a description of the same structures other than the coupling structure between the second lens 23 and the third lens 25 will be omitted.

In the lens module 200, the inner peripheral surface of the second extension part 25c of the third lens 25 may contact the outer peripheral surface of the second lens 23. For example, the inner peripheral surface of the second extension surface 25c includes a second tapered surface 25c-3 inclined at a predetermined angle in relation to the optical axis O, and the outer peripheral surface of the second lens 23 includes a second inclined surface 23b-2 inclined to contact the second tapered surface 25c-3. Accordingly, when the third lens 25 is coupled to the lens barrel 10, the second tapered surface 25c-3 of the third lens 25 and the second inclined surface 23b-2 of the second lens 23 contact each other. Since the third lens 25 directly supports the second lens 23, the second lens 23 is more stably fixed. As set forth above, the lens module may prevent the occurrence of assembly deviation during the process of assembling the lenses.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module comprising:
a first lens comprising a first extension part extending from an outer edge of the first lens;
a second lens disposed on the first lens and contacting an inner peripheral surface of the first extension part; and
a third lens disposed on the second lens and contacting a lower surface of the first extension part.

2. The lens module of claim 1, wherein the inner peripheral surface of the first extension part comprises a first tapered surface inclined at a predetermined angle in relation to an optical axis.

3. The lens module of claim 2, wherein an outer peripheral surface of the second lens comprises a first inclined surface inclined to contact the first tapered surface.

4. The lens module of claim 3, wherein the inner peripheral surface of the first extension part comprises a vertical surface extending from the first tapered surface in a direction of the optical axis.

5. The lens module of claim 4, wherein a gap is provided between the outer peripheral surface of the second lens and the vertical surface.

6. The lens module of claim 1, wherein the third lens comprises a second extension part extending from an outer edge thereof towards the first extension part.

7. The lens module of claim 6, wherein the lower surface of the first extension part contacts an upper surface of the second extension part.

8. The lens module of claim 7, wherein the lower surface of the first extension part and the upper surface of the second extension part are perpendicular to the optical axis.

9. The lens module of claim 6, wherein an inner peripheral surface of the second extension part contacts an outer peripheral surface of the second lens.

10. The lens module of claim 9, wherein the inner peripheral surface of the second extension part includes a second tapered surface inclined at a predetermined angle in relation to the optical axis, and
the outer peripheral surface of the second lens includes a second inclined surface inclined to contact the second tapered surface.

11. A lens module comprising:
a lens barrel;
a first lens coupled to an inner peripheral surface of the lens barrel;
a second lens coupled to an inner peripheral surface of a first extension part of the first lens; and
a third lens disposed on the second lens, coupled to the inner peripheral surface of the lens barrel, and contacting the first lens.

12. The lens module of claim 11, wherein the first extension part of the first lens extends from an outer edge of the first lens, and
an outer peripheral surface of the first extension part contacts the inner peripheral surface of the lens barrel.

13. The lens module of claim 11, wherein the third lens includes a second extension part extended from an outer edge thereof, and
an outer peripheral surface of the second extension part contacts the inner peripheral surface of the lens barrel.

14. The lens module of claim 13, wherein an inner peripheral surface of the second extension part contacts an outer peripheral surface of the second lens.

15. A lens module comprising:
a first lens;
a third lens contacting the first lens; and
a second lens disposed in a space between the first lens and the third lens, wherein in the second lens is in contact with the first lens, the third lens or both.
